(19) United States
(12) Patent Application Publication
(10) Pub. No.: US 2009/0174553 A1
(43) Pub. Date: Jul. 9, 2009

(54) ELECTROMAGNETIC DOOR LOCK

(76) Inventor: Tsung Chih Chang, Shanghai (CN)

Correspondence Address: LADAS & PARRY LLP, 224 SOUTH MICHIGAN AVENUE, SUITE 1600, CHICAGO, IL, 60604, US

(21) Appl. No.: 12/091,951

(22) PCT Filed: Oct. 30, 2006
(86) PCT No.: PCT/AU2006/001624

§ 371 Date: Jul. 29, 2008

(30) Foreign Application Priority Data
Oct. 31, 2005 (CN) 200520046098.0

(51) Int. Cl. G08B 13/08

(52) U.S. Cl. 340/545.3

(57) ABSTRACT

An electromagnetic door lock is described which includes at least two external generally planar surfaces and light emitting means; the light emitting means indicates the status of the lock and is arranged to emit light from the at least two external surfaces.

### TECHNICAL FIELD

This invention relates to an electromagnetic door lock.

### BACKGROUND TO THE INVENTION

An example of a known type of door lock is shown in FIGS. 1 and 2. A steel armature plate 6 is installed on a door and an electromagnetic lock 1 is mounted on the door frame to align with the armature plate. The electromagnetic lock 1 has the general outer shape of a cuboid. Its top plane is an installation plane, which is installed on the doorframe and its bottom plane carries a small LED 2, which indicates whether the door is closed or open. The LED can indicate the door status through different colour changes or blinking colours. However, the identification of the lock status based on the colour of the LED light is greatly limited in scope, as the light emitting device is small and not easy to see from a distance. Thus, people are unable to determine the status of the door lock from a distance and the function of warning and alarm signals is compromised.

### SUMMARY OF THE INVENTION

In a first aspect the present invention provides an electromagnetic door lock which includes at least two external generally planar surfaces and light emitting means; the light emitting means indicates the status of the lock and is arranged to emit light from the at least two external surfaces.

The lock may further include an inductive component which controls operation of the light emitting means in response to changes in magnetic field strength.

The lock may further include a switch which operates in response to the lock opening and closing.

The light emitting means may include an LED.

The light emitting means may include a luminescent light emitter.

The light emitting means may indicate status of the lock including: closed, open, locked, unlocked, or escape alert.

The light-emitting display device may indicate an alert signal.

The alert signals may include: flashing colour, non flashing colour, graph, animated picture, or text.

The lock may further be arranged to produce an audio effect accompanying the alert signal.

### BRIEF DESCRIPTION OF THE DRAWINGS

An embodiment of the present invention will now be described, by way of example only, with reference to the accompanying drawings, in which:

FIG. 1 is a perspective view of a prior art electromagnetic lock;

FIG. 2 is a view of the electromagnetic lock of FIG. 1 installed on a door frame;

FIG. 3 is a perspective view of an electromagnetic door lock;

FIG. 4 is a view of the door lock of FIG. 3 installed on a door frame;

FIG. 5 is a perspective view of another door lock;

FIG. 6 is a bottom perspective view of the door lock of FIG. 5;

FIG. 7 is a view of another door lock;

FIG. 8 is a cross sectional view of a door lock; and

FIG. 9 is another cross sectional view of a door lock.

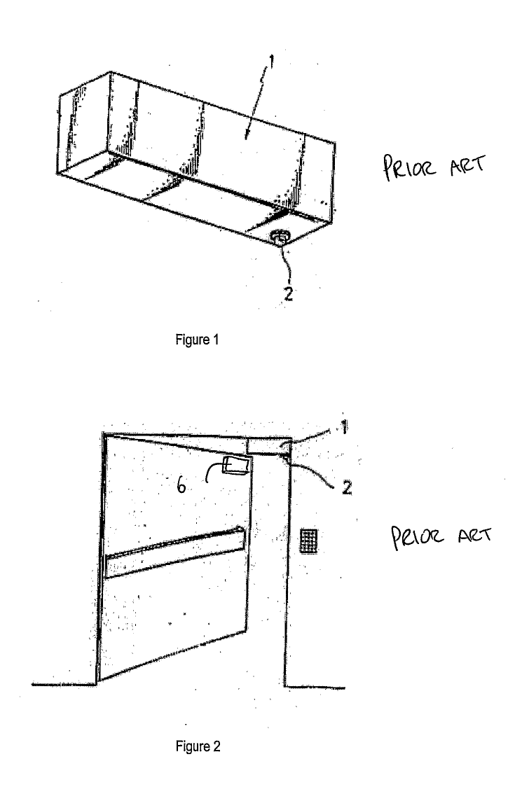

### DETAILED DESCRIPTION OF THE PREFERRED EMBODIMENT

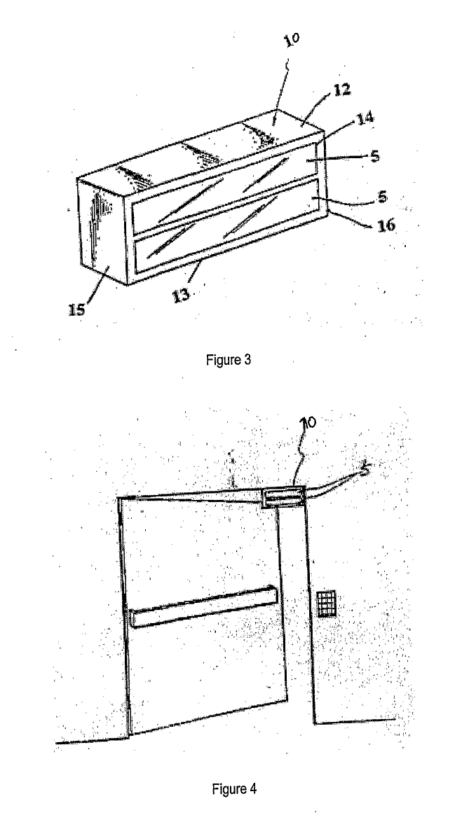

Referring to FIGS. 3 and 4 an electromagnetic door lock 10 is shown. The lock has a generally cuboid shape defined by upper and lower surfaces 12, 13 end surfaces 15, 16 and front and rear surfaces 14, 11. Light emitting means in the form of two LED backlight modules 5 are mounted on front surface 14 of lock 10.

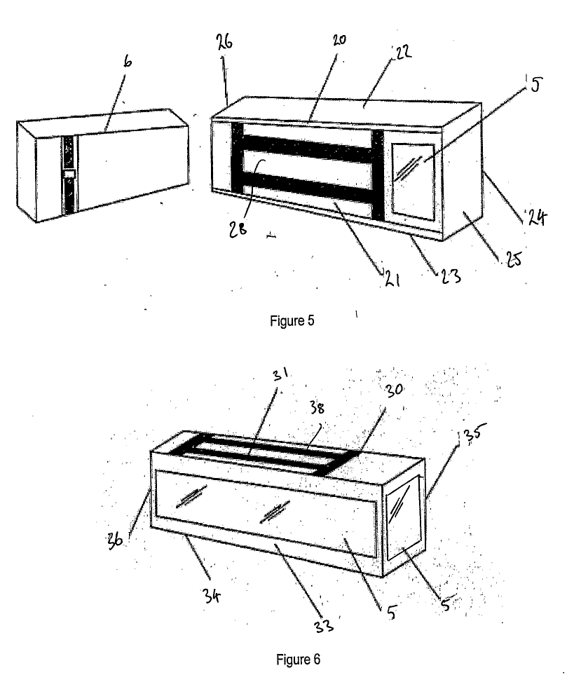

Referring to FIG. 5, an alternative version of lock 20 is shown and like reference numerals are used to indicate features corresponding to the lock shown in FIGS. 3 and 4. In this embodiment a light emitting means 5 is provided on the rear surface 21 of the lock alongside the electromagnet 28.

Referring to FIG. 6, another version of lock 30 is shown. In this embodiment, light emitting means 5 are mounted on both the bottom surface 33 and on end surface 35.

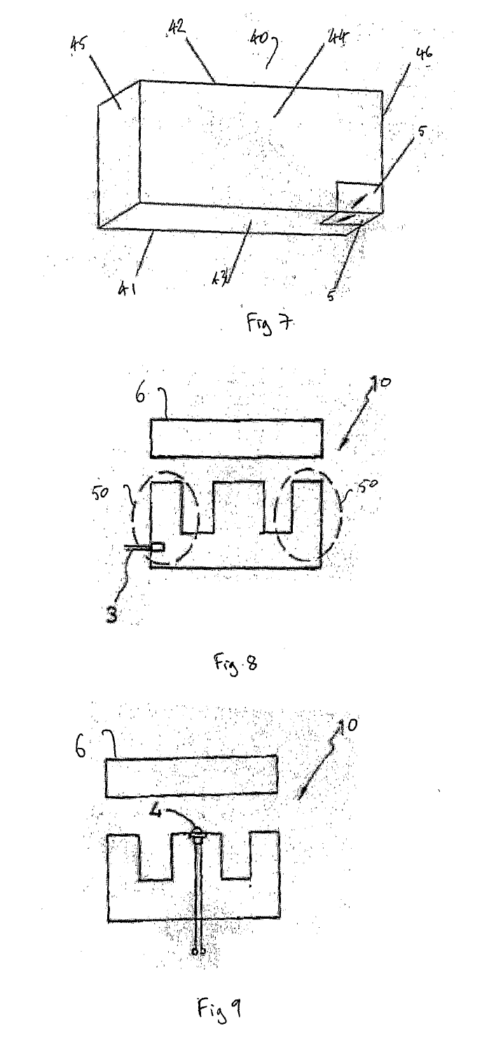

Referring to FIG. 7, another version of lock 40 is shown. In this version light emitting means 5 are provided on front surface 44 and bottom surface 43.

As shown in FIG. 9, an inductive component in the form of sensor 3 such as a reed switch or Hall sensor is set in magnetic lock 10. When the magnetic lock 10 is switched on a magnetic field 50 is generated in the lock. Sensor 3 detects the presence or absence of the magnetic field and so the output of sensor 3 indicates whether the electromagnet is activated. This allows remote sensing of whether the lock is “locked” or “unlocked”. The output of sensor 3 is used to control activation of light emitting means 5.

As shown in FIG. 10, a pressure switch 4 is located on the front edge of the magnetic lock 10. Pressure switch 4 becomes closed when the armature plate 6 is against lock 10. Thus, output of micro switch 4 indicates whether the door is “open” or “closed”. This allows remote sensing of the position of the door. The output of microswitch 4 is used to control activation of light emitting means 5.

A buzzer or a voice composite player is built inside or outside the magnetic lock 10 and is connected in serial manner with the access control system to provide the following audible status alarm information: The corresponding voice prompt is given when the door lock is opened normally, when the door is closed, or when an emergent status is switched on, such as evacuation of people in the case of fire. This buzzer or voice composite player can be connected in serial manner to the fire control alert system or the theft-proof pressure conductor. The voice prompt will also be given in case of non-malicious trespass.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. An electromagnetic door lock which includes at least two external generally planar surfaces and light emitting means; the light emitting means indicates the status of the lock and is arranged to emit light from the at least two external surfaces.

2. An electromagnetic lock according to claim 1 further including an inductive component which controls operation of the light emitting means in response to changes in magnetic field strength.

3. An electromagnetic lock according to claim 1 further including a switch which operates in response to the lock opening and closing.

4. An electromagnetic lock according to claim 1 wherein the light emitting means includes an LED.

5. An electromagnetic lock according to claim 1 wherein the light emitting means includes a luminescent light emitter.

6. An electromagnetic lock according to claim 1 wherein the light emitting means includes a backlight module.

7. An electromagnetic lock according to claim 1 wherein the light emitting, means indicates status of the lock including: closed, open, locked, unlocked, or escape alert.

8. An electromagnetic lock according to claim 1 wherein the light emitting display device indicates an alert signal.

9. An electromagnetic lock according to claim 8 wherein the alert signals include: flashing colour, non-flashing colour, graph, animated picture, or text.

10. An electromagnetic lock according to either claim 8 which is further arranged to produce an audio effect accompanying the alert signal.
